(19) United States
(12) Patent Application Publication
(10) Pub. No.: US 2004/0011950 A1
(43) Pub. Date: Jan. 22, 2004

(54) Parameter sensing apparatus and method for subterranean wells

(76) Inventor: Gary O. Harkins, Bakersfield, CA (US)

Correspondence Address: Dan C.Hu, TROP, PRUNER & HU, P.C., Ste.100, 8554 Katy Freeway, Houston, TX, 77024, US

(21) Appl. No.: 10/441,685

(22) Filed: May 20, 2003

Related U.S. Application Data
(60) Provisional application No. 60/384,475, filed on May 31, 2002.

(51) Int. Cl. G01V 5/08

(52) U.S. Cl. 250/269.1

(57) ABSTRACT

Fiber optic cable is daisy-chained between a plurality of wells. Rather than terminating a piece of fiber optic cable down each well, the fiber optic cable is disposed down, then back up a plurality of wells at once. Using the fiber optic cable, a parameter of interest is measured in each of the wells. The parameter may be temperature which can be sensed by sending optical signals down the fiber optic cable, then measuring the backscattered signals. In one implementation, steam injected into one or more wells is adjusted based upon the parameter readings.

### CROSS REFERENCE TO RELATED APPLICATION

This claims the benefit under 35 U.S.C. § 119(e) of U.S. Provisional Application No. 60/384,475, titled “Daisy Chain Parameter Sensing Apparatus and Method,” filed May 31, 2002.

### FIELD OF THE INVENTION

This invention relates to downhole parameter sensing and, more particularly, to dispensing a fiber optic cable down a plurality of wellbores to measure a parameter, such as temperature.

### BACKGROUND OF THE INVENTION

Parameters, such as temperature, pressure, strain, flow, or chemical properties, are often measured by sensors deployed in subterranean wells, including hydrocarbon production, injection, remediation, and decontamination wells. The information obtained by the sensors is then used by the relevant operator to monitor the relevant operations

Fiber optic sensors are being increasingly used in subterranean wells. The fiber optic sensor is normally deployed on a fiber optic cable, which cable is inserted into the well and is attached at the surface to a light source and interrogation system. Light is sent from the light source down the fiber optic cable, and a return light signal is returned up the fiber optic cable from the fiber optic sensor. The signature of the return light wave has a direct relationship to the parameter value sensed by the fiber optic cable. The light source and interrogation system receives the return light signal and derives the parameter value by reading the signature of the return light signal.

Often times, fiber optic cables have to be spliced in order to be connected to or passed through other items in the well or at the surface. However, the splicing of fiber optic cables causes undesired signal attenuation.

Fiber optic cables are used in various types of operations in subterranean wells. For example, remediation, or decontamination, is one operation that may involve subterranean wells. Remediation is performed to correct adverse environmental conditions in wells. Waste from oilfield operations, some of which is dangerous to the land environment, is removed, reduced, or neutralized during remediation. One remediation technique is steam injection. At remediation sites, a number of injection and often extraction wells are drilled.

Injection and extraction wells are typically arranged in a pattern, with injection wells typically surrounding the extraction wells. Five spot and seven spot well patterns are common. The subsurface geology, the location of contaminants, the desired steam injection rate, and other factors also affect well placement.

Steam injection systems often include a single steam generator coupled to the injection wells, an extraction system, such as a pump, coupled to the extraction wells, condensers for treating the extracted fluids, gas treatment systems, and a water treatment system for the steam generator. Blowers and heat exchangers can also be part of the operation.

The duration and rate of steam injection are highly subjective, affected by the placement and depth of the wells and the contaminant being flushed, the geology of the site, and other factors. Because of the vast differences in subsurface topology for each decontamination site, remediation is often an empirical operation.

Typical remediation operations can last months, or even years. Steam operations may be continuous or intermittent. Intermittent operations sometimes increase the stress of the steam injection equipment, due to the frequent cooling and heating of the generator. Continuous operations are costly in terms of labor and energy use.

Temperature measurements monitor the movement of steam and water directly. The effective tracking of the subsurface temperature of the site can thus be a valuable tool during steam injection operations.

### SUMMARY OF THE INVENTION

In general, according to one embodiment, a method of taking measurement of wells includes disposing a fiber optic cable in a plurality of wells such that portions of the fiber-optic cable are disposed in respective wells. The method further includes receiving an optical signal from the fiber optic cable. A parameter in at least one of the wells is determined based on the received optical signal.

Other or alternative features will become apparent from the following description, from the drawings, and the claims.

### BRIEF DESCRIPTION OF THE DRAWINGS

FIG. 1 is a diagram of a daisy chain sensing apparatus according to one embodiment of the invention;

FIG. 2 is a diagram of the thermal profile processing unit according to one embodiment of the invention;

FIG. 3 is a diagram of remote communication of the sensing information produced by the daisy chain sensing apparatus according to one embodiment of the invention;

FIG. 4 is a diagram of the on-site processing of the sensing information produced by the daisy chain sensing apparatus according to one embodiment of the invention;

FIG. 5 is a diagram of the daisy chain sensing apparatus used in one well according to one embodiment of the invention; and

FIG. 6 is a flow diagram of a process performed by the daisy chain sensing apparatus according to one embodiment of the invention.

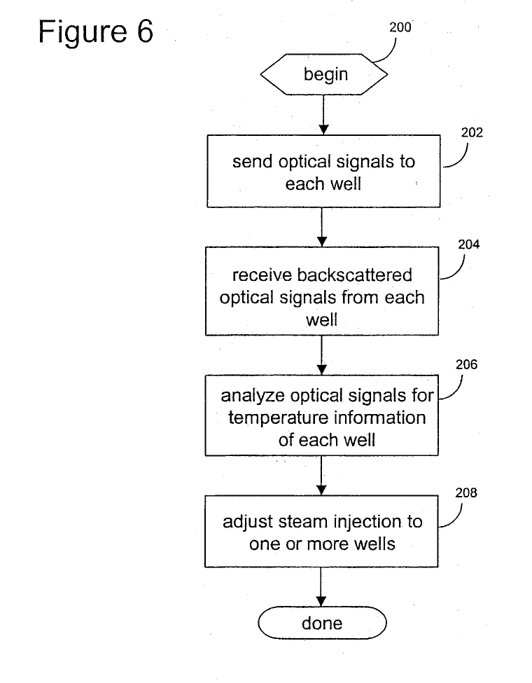

### DETAILED DESCRIPTION

In accordance with some embodiments, methods and apparatus are disclosed in which a fiber optic cable is daisy-chained between wells. The wells can be any type of wells, including hydrocarbon production wells, injection wells, in addition to wells that are part of a remediation site or steam flood site. Rather than terminating a piece of fiber optic cable down each well of the asset, the fiber optic cable is disposed down, then back up each well. Thus, each well has a continuous loop of fiber optic cable disposed within.

Using the fiber optic cable, a parameter of interest is measured in each of the wells. The parameter may be temperature which can be sensed by sending optical signals down the fiber optic cable, then measuring the backscattered signals. The redundant placement of the fiber optic cable assures accurate temperature measurements. In one embodiment, steam injected into one or more wells is modified based upon the parameter readings. Other downhole parameters that can be measured include pressure, strain, chemical property, flow rate, and so forth.

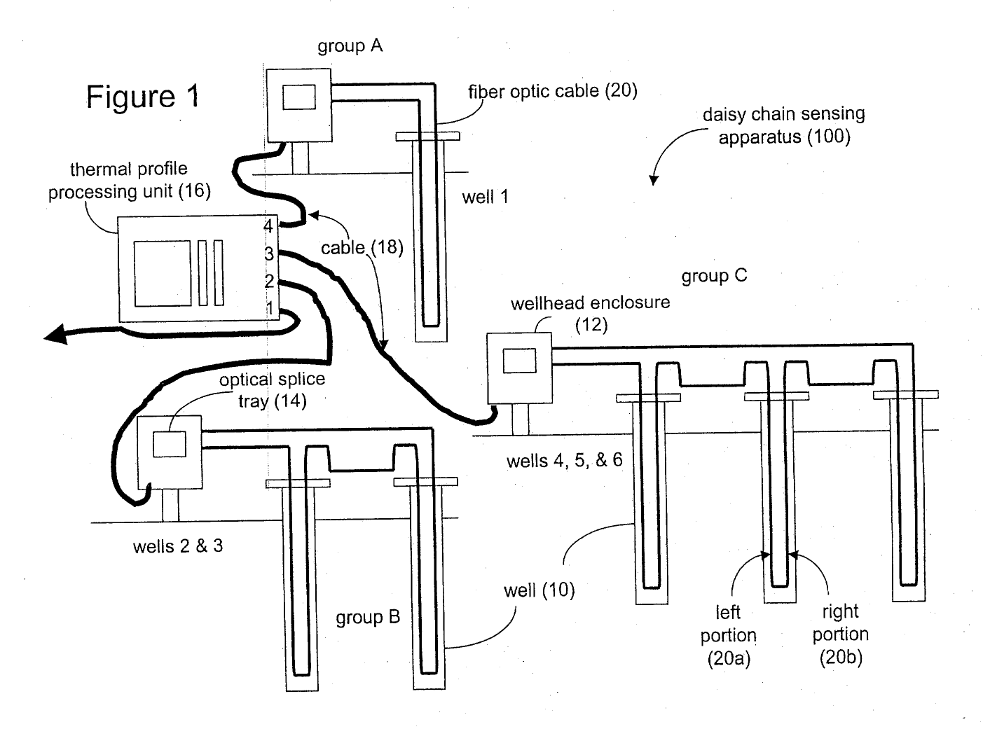

In FIG. 1, according to one embodiment, a daisy-chain sensing apparatus 100 is depicted for use in a well environment having multiple wells 10. The sensing apparatus 100 includes fiber optic cable 20, pumped down, then back up, each well 10. As shown in FIG. 1, a loop of cable, comprising a left portion 20a and a right portion 20b, is positioned in the well. As used here, a “loop” of a fiber optic cable does not necessarily require a complete loop, but rather can refer to a portion of the fiber optic cable including a first segment extending from a well surface into a well and a second segment extending from the first segment and exiting the well. Effectively such a loop includes two segments of the same fiber optic cable that are parallel to each other.

The example well environment of FIG. 1 includes six wells 10, with the wells 10 positioned in three groups. Group A includes a single well, denoted well 1. Fiber optic cable is disposed down, then back up the well as a unitary piece. Group B includes two wells (well 2 and well 3). A unitary length of fiber optic cable 20 is disposed down both wells 2 and 3 of group B, as shown. Group C includes three wells (well 4, well 5, and well 6). A unitary length of fiber optic cable is disposed, in a daisy-chain fashion, down each of wells 4, 5, and 6. It is understood that each well group can include any number of wells. Also, although only one fiber optic cable is used in each group of wells in the example of FIG. 1, plural fiber optic cables can be provided in each group in other embodiments.

Deployment of the fiber optic cable into each well group can be achieved by pumping the fiber through a control line by use of fluid drag. This “pumping” deployment technique is explained in U.S. Pat. No. Re 37,283, which is incorporated herein by reference. Other deployment techniques can also be used.

Each well group has a wellhead enclosure 12 comprising an optical splice tray 14. Both ends of the fiber optic cable 20 can be terminated at the wellhead enclosure 12 in each group. The optical splice tray 14 holds the two ends of the fiber optic cable 20 in place inside the wellhead enclosure 12 to enable engagement of the fiber optic cable 20 to a thermal profile processing unit 16.

According to some embodiments, the fiber optic cable 20 is not spliced between portions of the fiber optic cable in respective wells. Splicing a cable refers to uniting two separate pieces of cable into one cable. Splices in fiber optic cables lead to undesired signal attenuation. Thus, being able to “daisy chain” a fiber optic cable into two or more wells without the use of splices provides a benefit. Instead of splicing separate cables of different wells into one cable, a unitary cable is used in multiple wells that avoids the signal attenuation issues of splices.

Each wellhead enclosure 12 can also be connected to a dedicated cable 18. The three cables 18 from each of Groups A, B, and C, are connected to the thermal profile processing unit 16. In one embodiment, the cables 18 are also fiber optic cables through which the optical signals pass to and from the thermal profile processing unit.

In another embodiment, the fiber optic cable 20 of each group is directly connected to its own respective thermal profile processing unit 16 (instead of through the wellhead enclosure 12). It is also noted that any number of well groups may be used in other embodiments of the invention.

Temperature Sensing

The system shown in FIG. 1 includes a distributed temperature sensor that measures the temperature profile along the fiber optic cable 20. In one embodiment, DTS includes an optical time domain reflectometry (OTDR) system such as those described in U.S. Pat. Nos. 4,823,166 and 5,592,282, both of which are incorporated herein by reference.

In OTDR, a pulse of optical energy is launched into an optical fiber and the backscattered optical energy returning from the fiber is observed as a function of time, which is proportional to distance along the fiber from which the backscattered light is received. This backscattered light includes the Rayleigh, Brillouin, and Raman spectrums. The Raman spectrum is the most temperature sensitive with the intensity of the spectrum varying with temperature, although Brillouin scattering and in certain cases Rayleigh scattering are temperature sensitive. Generally, in one embodiment, pulses of light at a fixed wavelength are transmitted from a light source in the DTS instrument down the fiber optic cable. Light is back-scattered along the length of the fiber optic cable and returns to the DTS instrument. Knowing the speed of light and the moment of arrival of the return signal enables its point of origin along the fiber optic cable to be determined. Temperature stimulates the energy levels of molecules of the silica and of other index-modifying additives such as germania present in the fiber optic cable. The back-scattered light contains upshifted and downshifted wavebands (such as the Stokes Raman and Anti-Stokes Raman portions of the back-scattered spectrum) which can be analyzed to determine the temperature at origin. In this way the temperature along the fiber optic cable can be calculated by the DTS instrument, providing a complete temperature profile along the length of the fiber optic cable.

Thermal Profile Processing Unit

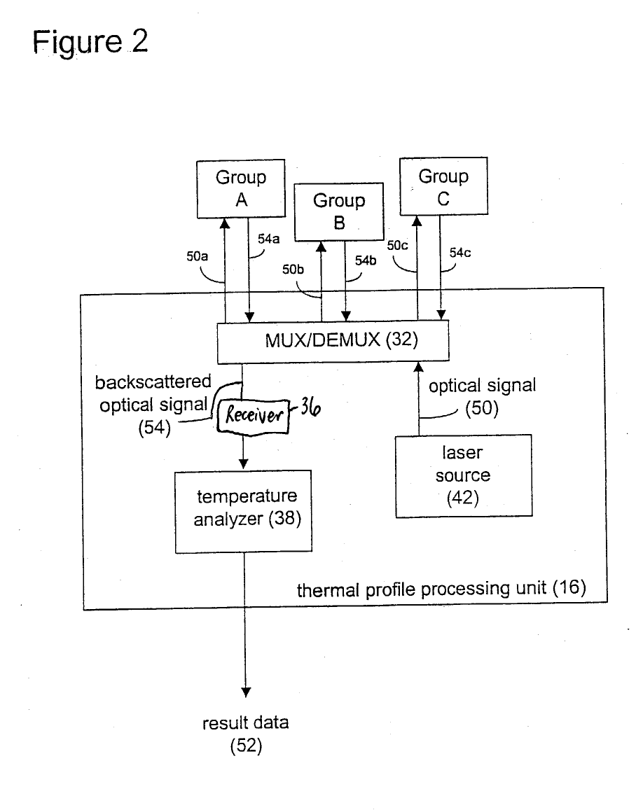

In one embodiment, the thermal profile processing unit 16 transmits optical signals to the groups of wells, as depicted in FIG. 2. A laser source 42 produces an optical signal 50 for transmission through the fiber optic cable 20. In the embodiment including more than one well group, the optical signal 50 is multiplexed by a multiplexed/demultiplexer 32 into (for example) three optical signals 50a, 50b, and 50c, for receipt by the respective groups of wells.

The thermal profile processing unit 16 further includes circuitry for receiving backscattered optical signals from the wells 10. Backscattered optical signals 54a, 54b, and 54c are received into the multiplexer/demultiplexer 32. The multiplexer/demultiplexer 32 combines backscattered optical signals 54a, 54b, and 54c, from respective Groups A, B, and C, respectively, into a single backscattered optical signal 54. The combined optical signal is received by a receiver 36.

As used herein, the backscattered optical signals 54 are optical signals that travel down the fiber optic cable in a direction opposite to the original optical signals 50. It may be expected that the backscattered optical signals and the original optical signals are simultaneously present in the fiber optic cable. The backscattered optical signals travel back toward the source of the original optical signals.

The daisy-chain sensing apparatus 100 is thus a two-way system in which an optical signal is transmitted to fiber optic cables positioned down various wells. Simultaneously, backscattering from these pulses are transmitted back up the fiber optic cables to the thermal profile processing unit 16 to be measured for thermal information or information relating to other downhole parameters.

In one embodiment, the thermal profile processing unit 16 is a processor-based system capable of analyzing the backscattered optical signal 54 to obtain a temperature profile of the wells. Accordingly, the unit includes a temperature analyzer 38, which receives the optical signal 54 from the receiver 36 and produces result data 52, which may be transmitted to a remote location. In one embodiment, the temperature analyzer 38 is a software program executed by a processor (not shown). The result data 52 may optionally be converted to an electrical signal, for transmission to remote locations.

In the embodiment shown in FIG. 1, the thermal profile processing unit 16 includes four connections, labeled 4, 3, 2, and 1, connected to four respective cables 18. One cable (labeled “1”) transmits the processed result data 52 to another location. The location may be another processor-based system, such as a laptop computer, a printer or video display, for viewing, or a hard disk drive, for storage.

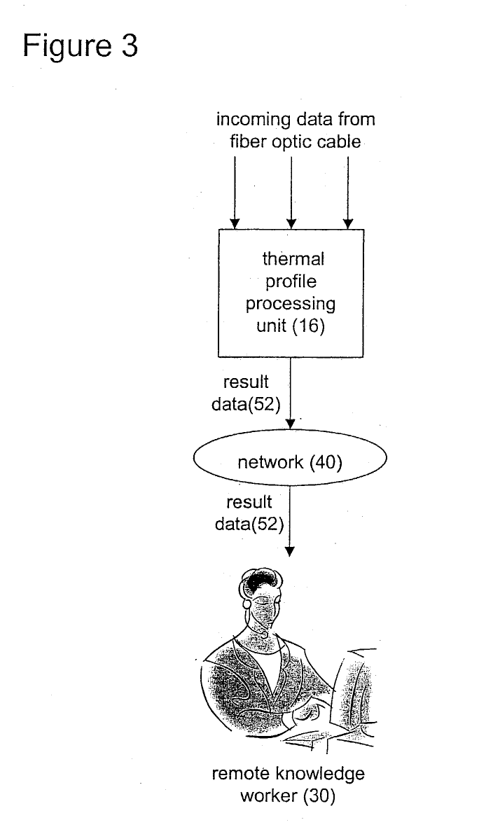

The thermal profile processing unit 16 can be coupled to a network 40, as depicted in FIG. 3. The network 40 can be a local area network, such as an intranet or other private network or can be a public network, such as the Internet. Once communicated on to the network 40, the result data 52 can be retrieved by one or more remote knowledge workers 30 for further analysis.

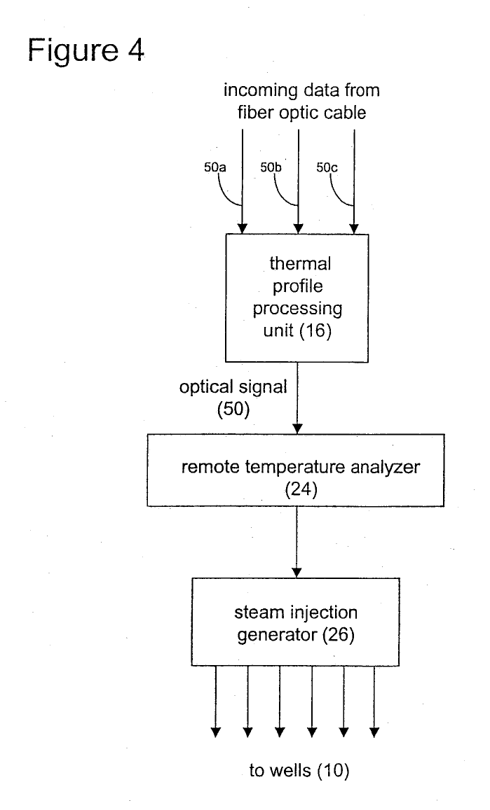

In another embodiment, as depicted in FIG. 4, the thermal profile processing unit 16 does not perform temperature analysis, but, instead, transmits the optical signal 50 to a remote temperature analyzer 24. The remote temperature analyzer 24 is a processor-based system including software for receiving and analyzing the backscattered optical signal 54. The analysis is performed to determine the necessary data on a well-by-well basis.

In one embodiment, the thermal profile processing unit 16 can be used to monitor steam injection that is part of a steam flood operation. In this embodiment, the remote temperature analyzer 24 is coupled to a steam injection generator 26, which injects steam into each well. When the remediation operation begins, the steam injection generator 26 may dispense steam equally to each of the six wells. However, once the thermal profile processing unit 16 obtains data from the wells, adjustment to the steam distribution can enhance recovery. Accordingly, the steam injection generator 26, upon receiving direction or data from the temperature analyzer 24, can increase or decrease the steam dispensed to one or more wells.

The daisy-chain arrangement of the fiber optic cable 20 within each well group facilitates temperature measurement. The fiber optic cable 20 is looped inside each well bore and continued to the next adjacent bore. Measurements taken at any point of the fiber optic cable within a well may advantageously be correlated to a corresponding measurement taken at a second point of the fiber optic cable. Since the two measurement points are adjacent to one another, a temperature taken at one point is expected to be very close to a temperature taken at the second point.

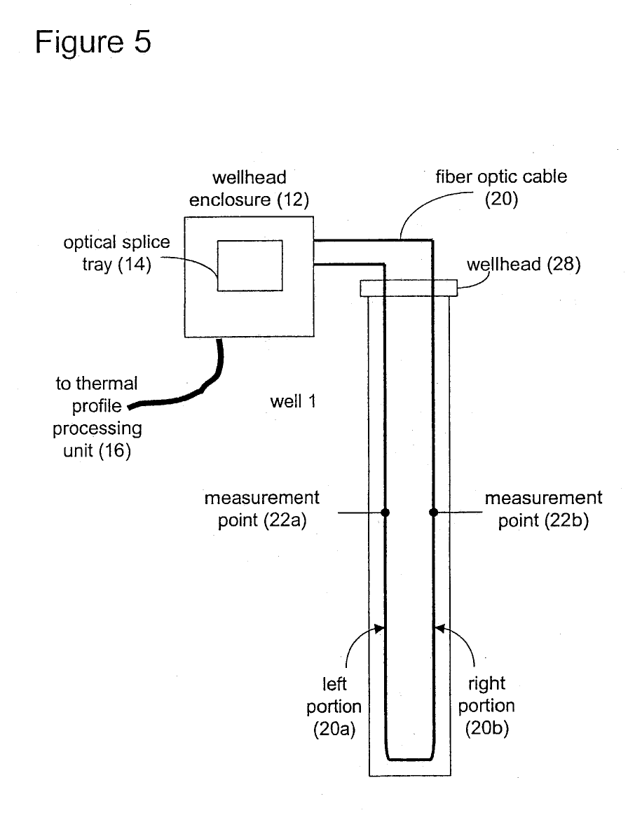

This principle is illustrated in FIG. 5. The unitary fiber optic cable 20 is looped and sent down the well 10, such that two fiber optic portions 20a and 20b are adjacent and parallel to one another. A measurement point 22a is indicated at the same horizontal plane as a measurement point 22b. Note that many measurement points can be defined along the fiber optic cable.

Since the two measurement points are in the well bore at the same distance from the wellhead 28, similar, if not identical, temperature measurements are expected from each measurement point. Such redundancy of temperature information assures integrity of the measurements obtained. Accordingly, one or more of the wells can be precisely adjusted, for more efficient steam injection operations. Further, isothermal profiles for the entire remediation project may be developed quickly and easily using this technique.

Where multiple wells are measured by a single optical fiber cable, the thermal profile processing unit is able to know the measurement point in a particular well a measurement is for. Since the speed of light is constant, a signal arriving at time X comes from a first point (which may be located in a first well), while another signal arriving at time X+n comes from a second point (which may be located in a second well). A temperature profile along the entire length of the fiber optic cable 20, including knowing the position (which well and what depth) of each temperature measuring point, may therefore be known, regardless of the number of wells into which the cable 20 is deployed.

A flow diagram illustrates operation of the daisy chain sensing apparatus. 100, according to one embodiment. The thermal profile processing unit sends optical signals through the fiber optic cable to each well (block 202), such as by transmitting a laser pulse. Backscattered optical signals are received by the thermal profile processing unit, again through the fiber optic cable (block 204).

In one embodiment, the optical signals are analyzed for temperature information of each well (block 206). Based upon the analysis, the steam injection to one or more wells is adjusted (block 208).

By use of the daisy-chain method, temperature on all wells can be monitored simultaneously to detect if operations on one well are interfering with another well that is close by.

Some embodiments of the invention has been described so that temperature is monitored in the relevant wells. However, other types of fiber optic sensors may be deployed on the fiber optic cable 20, including pressure, strain, chemical property, and flow sensors.

While the invention has been described with respect to a limited number of embodiments, those skilled in the art will appreciate numerous modifications and variations therefrom. It is intended that the appended claims cover all such modifications and variations as fall within the true spirit and scope of the invention.

What is claimed is:

1. A method of taking measurements of parameters in wells, comprising:
disposing a fiber optic cable in a plurality of wells such that portions of the fiber optic cable are disposed in respective wells;
receiving an optical signal from the fiber optic cable; and
determining a parameter in at least one of the wells based on the received optical signal.

2. The method of claim 1, further comprising pumping the fiber optic cable through a control line by use of fluid drag.

3. The method of claim 1, wherein receiving the optical signal comprises receiving a backscattered optical signal.

4. The method of claim 3, further comprising pumping the fiber optic cable through a control line by use of fluid drag.

5. The method of claim 1, wherein disposing the fiber optic cable in the plurality of wells is accomplished without splicing the fiber optic cable between portions of the fiber optic cable in the respective wells.

6. The method of claim 1, wherein determining the parameter comprises determining a temperature.

7. The method of claim 6, wherein determining the temperature comprises determining the temperature during a steam injection operation.

8. The method of claim 7, further comprising adjusting steam injection based on the determined temperature.

9. A method for obtaining information of subterranean wells, comprising:
disposing a fiber optic cable in a plurality of wells such that a first portion of the cable extends from one of the wells and a second portion extends from a second of the wells;
providing optical communication between the first portion of the fiber optic cable and a processing unit;
sending an optical signal through the fiber optic cable; and
ascertaining a parameter within the wells by the processing unit based upon a return optical signal.

10. The method of claim 9, wherein the parameter is temperature and the processing unit ascertains the temperature based upon a backscattered optical signal.

11. The method of claim 9, further comprising providing optical communication between the second portion of the fiber optic cable and the processing unit.

12. The method of claim 9, further comprising:
disposing a second fiber optic cable down each of a plurality of a second set of wells such that a first portion of the second cable extends from one of the wells and a second portion extends from a second of the wells;
providing optical communication between the first portion of the second fiber optic cable and the processing unit;
sending an optical signal through the second fiber optic cable; and
ascertaining a parameter within the second set of wells by the processing unit based upon a return optical signal from the second fiber optic cable.

13. The method of claim 12, further comprising:
coupling the first optic cable to a first wellhead enclosure;
coupling the first wellhead enclosure to the processing unit by way of a third cable;
coupling the second optic cable to a second wellhead enclosure; and
coupling the second wellhead enclosure to the processing unit by way of a fourth cable.

14. The method of claim 9, wherein the wells are part of a steam flood operation that includes the injection of steam, the method further comprising adjusting the steam injection into at least one of the wells based on the parameter measured.

15. An apparatus for measurement in wells, comprising:
a fiber optic cable to be disposed in a plurality of wells, the fiber optic cable having portions in respective wells; and
a unit to receive optical signals from the fiber optic cable to indicate values of a parameter of the plurality of wells.

16. The apparatus of claim 15, further comprising a mechanism to pump the fiber optic cable through a control line by use of fluid drag.

17. The apparatus of claim 15, wherein the fiber optic cable is to be disposed in the plurality of wells without splicing the fiber optic cable between portions of the fiber optic cable in respective wells.

18. The apparatus of claim 15, wherein each of the plural portions of the fiber optic cable comprises a first segment extending into a respective well and a second segment extending from the first segment and exiting the respective well.

19. The apparatus of claim 15, further comprising a steam injector to inject steam into at least one of the wells, the steam injector to adjust steam injection based on a value of the parameter from the unit.

20. The apparatus of claim 19, wherein the unit comprises a unit to sense temperature, the parameter comprising temperature.

21. The apparatus of claim 15, further comprising a processor to analyze the optical signals and to determine values of the parameters at plural points in the plurality of wells.

22. A daisy chain sensing apparatus comprising:
a fiber optic cable comprising a first end, a second end, and a plurality of loops, the loops being disposed down a plurality of wells; and
a processing unit for sending an optical signal to the fiber optic cable and for receiving a returning optical signal from the fiber optic cable;
wherein the returning optical signal is analyzed for parameter information about the plurality of wells.

23. The daisy chain sensing apparatus of claim 22, further comprising a mechanism to pump the fiber optic cable through a control line by fluid use of drag.

24. The daisy chain sensing apparatus of claim 22, wherein the parameter comprises temperature.

25. The daisy chain sensing apparatus of claim 22, wherein the plurality of wells are part of a steam flood operation.

26. The daisy chain sensing apparatus of claim 22, further comprising:
a wellhead enclosure coupled between a group of wells and the processing unit, the group of wells comprising at least one of the plurality of wells, wherein the wellhead enclosure receives the first end and the second end of the fiber optic cable.

27. The daisy chain sensing apparatus of claim 26, wherein a first loop of the plurality of loops comprises a first measuring point positioned at a first portion of the first loop and a second measuring point positioned at a second portion of the first loop, the first measuring point being physically close to the second measuring point, wherein the processing unit compares the returning optical signal from the first measuring point and from the second measuring point.

28. An article comprising at least a storage medium containing instructions that when executed cause a system to:
cause an optical signal to be sent through a fiber optic cable, wherein the fiber optic cable is disposed down a well in a loop comprising a first portion and a second portion such that the first portion and the second portion are both within the well;
ascertain a temperature within the well based upon a returning optical signal received from the fiber optic.

29. The article of claim 28, wherein the instructions when executed cause the system to further:
obtain a first temperature from a first measuring point, wherein the first measuring point is along the first portion of the loop of the fiber optic cable;
obtain a second temperature from a second measuring point, wherein the second measuring point is along the second portion of the loop of the fiber optic cable and the second measuring point is substantially adjacent to the first measuring point; and
compare the first temperature with the second temperature.
